(19) United States
(12) Patent Application Publication
(10) Pub. No.: US 2023/0419704 A1
(43) Pub. Date: Dec. 28, 2023

(54) IDENTIFICATION OF CANDIDATE REGIONS IN IMAGES FOR PREDEFINED OBJECT PLACEMENT

(71) Applicant: Hewlett-Packard Development Company, L.P., Spring, TX (US)

(72) Inventor: Lucas Nedel KIRSTEN, Porto Alegre (BR)

(73) Assignee: Hewlett-Packard Development Company, L.P., Spring, TX (US)

(21) Appl. No.: 17/850,719

(22) Filed: Jun. 27, 2022

(51) Int. Cl. G06V 30/412; G06V 10/26; G06V 30/196

(52) U.S. Cl. CPC G06V 30/412; G06V 30/1983; G06V 10/267

(57) ABSTRACT

According to examples, an apparatus may include a processor and a memory on which are stored machine-readable instructions that when executed by the processor, may cause the processor to receive an image and identify contents in the received image. The processor may identify candidate regions on the image at which a predefined object is placeable. In some examples, the processor may assign scores to the identified candidate regions based on relative positions of the identified candidate regions to respective ones of the identified contents in the image. Based on the assigned scores, the processor may select a candidate region among the identified candidate regions at which the predefined object is to be placed. The processor may determine a size and a position of the predefined object based on the selected candidate region, and may output the determined size and the position of the predefined object on the image.

### BACKGROUND

In general, imaging devices may be used to scan images of documents. In some instances, the scanned documents may include regions at which predefined objects are to be inserted. By way of particular example, electronic signatures may be inserted into signature lines in the scanned images.

### BRIEF DESCRIPTION OF THE DRAWINGS

Features of the present disclosure are illustrated by way of example and are not limited in the following figure(s), in which like numerals indicate like elements, in which:

FIG. 1 depicts a block diagram of an example apparatus that may identify candidate regions on an image at which a predefined object is placeable and select a candidate region among the identified candidate regions based on assigned scores;

FIG. 2 depicts a block diagram of an example system within which the example apparatus depicted in FIG. 1 may be implemented;

FIG. 3A shows diagrams of example images, which may be implemented in the system depicted in FIG. 2, including contents and candidate regions at which a predefined object may be placeable;

FIG. 3B shows diagrams of example images, which may be implemented in the system depicted in FIG. 2, including predefined keywords, contents, and candidate regions at which predefined objects may be placeable;

FIG. 4A shows a diagram of an example content detection algorithm to identify contents in the image;

FIG. 4B shows a diagram of an example candidate region detection algorithm to identify candidate regions in the image;

FIG. 4C shows a diagram of an example position information extraction and candidate region scoring algorithm to extract relative position information of identified candidate regions with respect to respective identified contents in the image, and to generate scores for the identified candidate regions based on the relative position information;

FIG. 4D shows a diagram of an example position information extraction and candidate region scoring algorithm to extract relative position information of predefined keywords and identified candidate regions with respect to respective identified contents in the image, and to generate scores for the identified candidate regions based on the relative position information;

FIG. 4E shows a diagram of an example content region resize and placement algorithm to determine a size and a position of a selected candidate region to determine a size and a position of a predefined object, which may be placeable in the selected candidate region;

FIG. 4F shows a diagram of an example complete algorithm that includes the algorithms depicted in FIGS. 4A to 4E to output a determined size and a position of a predefined object on an image;

FIG. 5 depicts a flow diagram of an example method for selecting a candidate region among identified candidate regions on an image and determining a size and a position of a predefined object based on the selected candidate region; and

FIG. 6 depicts a block diagram of an example computer-readable medium that may have stored thereon machine readable instructions that when executed by a processor, may cause the processor to select a signature line among identified candidate lines on an image, and to determine a size and a position of a signature object based on the selected signature line.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Imaging devices, such as scanners or mobile devices may scan or capture an image of a document. In some instances, the image of the document may include regions at which certain objects may be inserted. For instance, an image of the document may include signature lines at which signatures may be insertable. A concern with mobile scanners and general document handling software may be that it may be difficult to correctly place signatures, e.g., digital signatures, using, for instance, mobile devices or desktop computers. For instance, the relatively small display screens on mobile devices may make it difficult to correctly size and place signatures in correct regions on the documents. In cases of desktop computers, it may be difficult to identify correct regions to place signatures in cases where there are relatively large numbers of documents to be signed. As such, positioning and sizing of signatures in documents may be difficult.

Disclosed herein are apparatuses to identify the most probable regions at which predefined objects may be inserted in images of scanned documents. In some examples, a processor may identify candidate regions at which predefined objects, such as digital signatures, images such as logos, icons, avatars, pictures, and/or the like, predefined text such as names, titles, addresses, email addresses, and/or the like, may be placed on the images. The processor may assign scores to the respective identified candidate regions and may select a candidate region among the identified candidate regions to place the predefined object. The assigned scores may be based on relative positions of the respective identified candidate regions to a content in the image. In some examples, the processor may determine a size and a position of the predefined object based on the selected candidate region, and may output the determined size and the position of the predefined object to be placed on the image. In some examples, the processor may insert the predefined object at the selected candidate region on the image. The processor may insert an input field, such as a signature field, at the selected candidate region on the image, in which the predefined object, such as a digital signature, may be inserted.

Through implementation of the features of the present disclosure, in which the candidate regions, such as signature lines, may automatically be identified, a processor may reduce the amount of time to identify locations in documents at which objects, such as digital signatures are to be added, which in turn may reduce an amount of computing resources and time consumed in adding the objects to the documents.

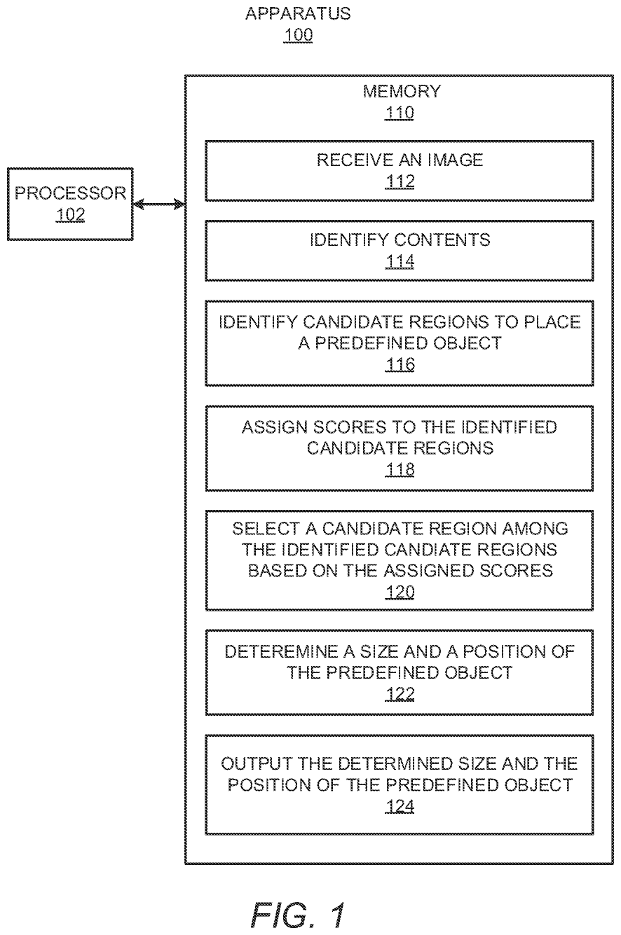

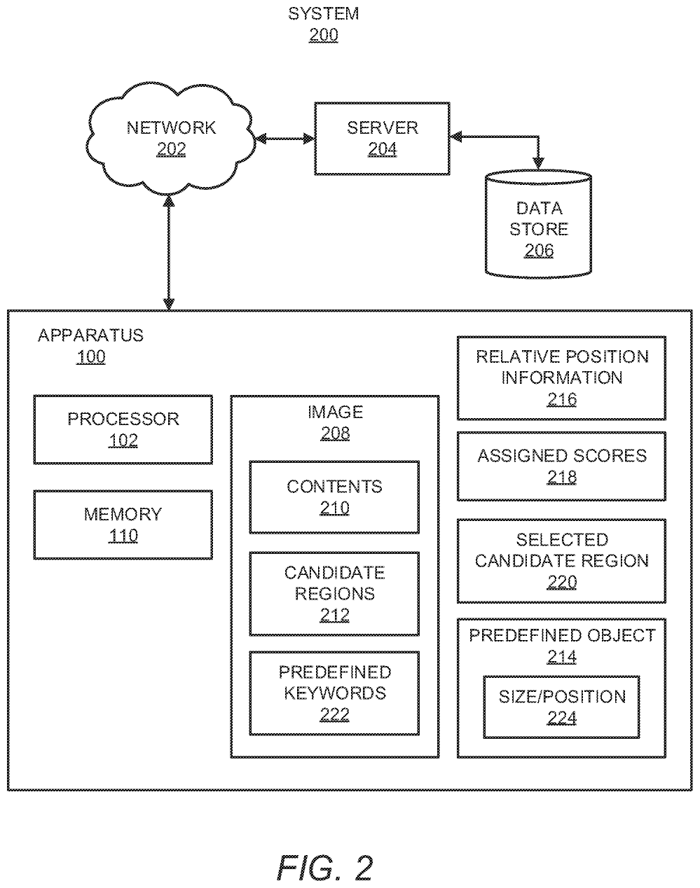

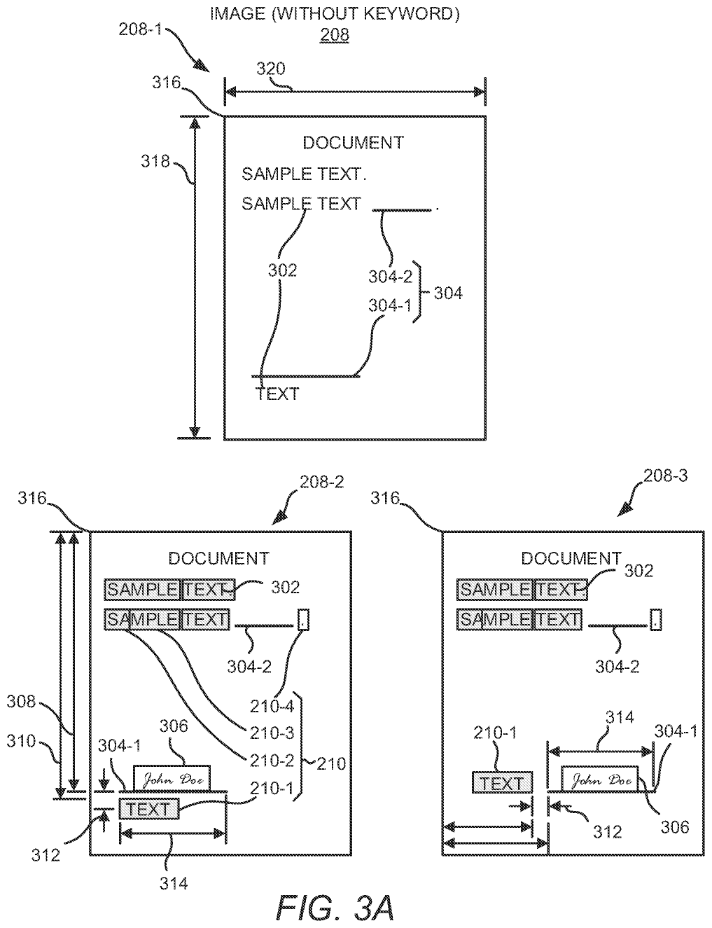

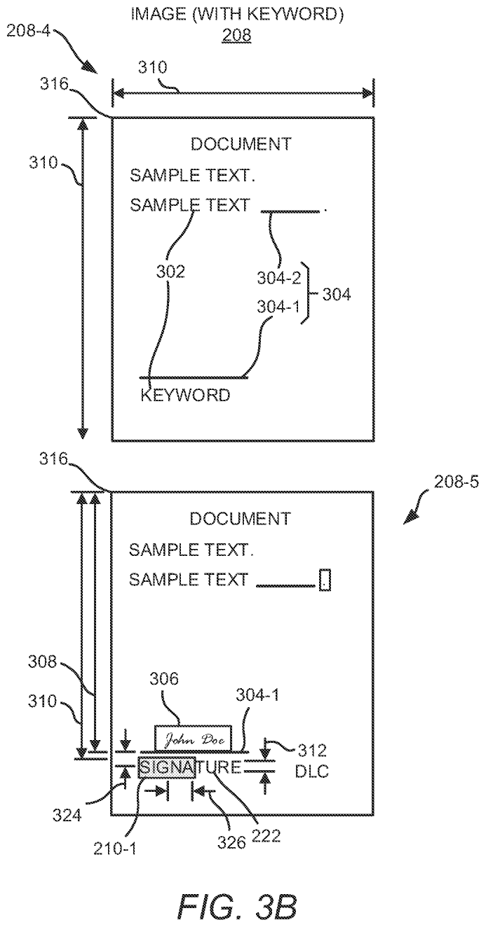

Reference is made to FIGS. 1, 2, 3A, 3B, and 4A to 4F. FIG. 1 depicts a block diagram of an example apparatus 100 that may identify candidate regions on an image at which a predefined object may be placeable, and select a candidate region among the identified candidate regions based on assigned scores. FIG. 2 depicts a block diagram of an example system 200 within which the example apparatus 100 depicted in FIG. 1 may be implemented. FIG. 3A shows diagrams of example images 208, which may be implemented in the system 200 depicted in FIG. 2, including contents and candidate regions at which a predefined object may be placeable, and FIG. 3B shows diagrams of example images 208, which may be implemented in the system 200 depicted in FIG. 2, including predefined keywords, contents, and candidate regions at which predefined object may be placeable.

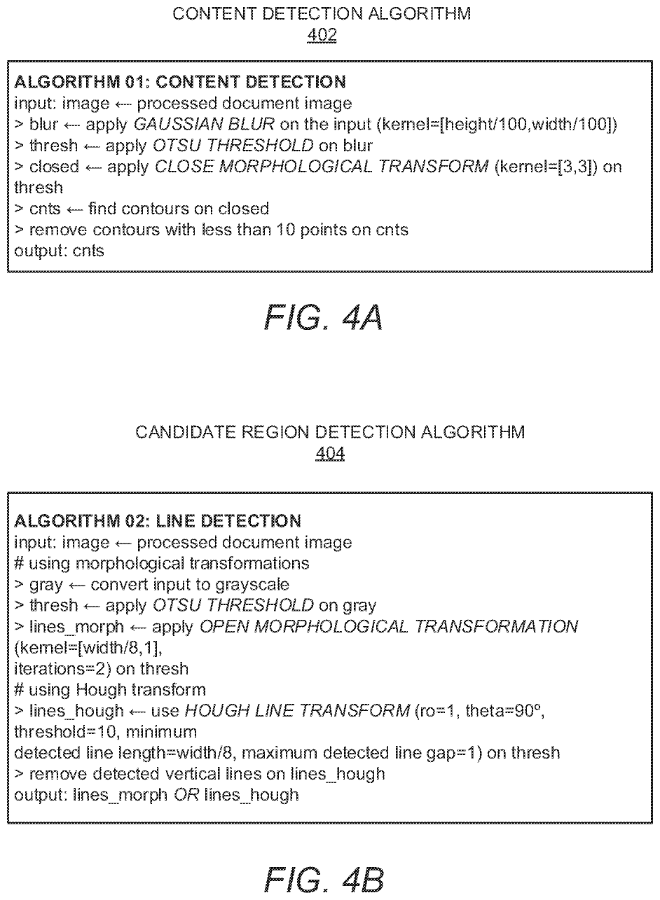

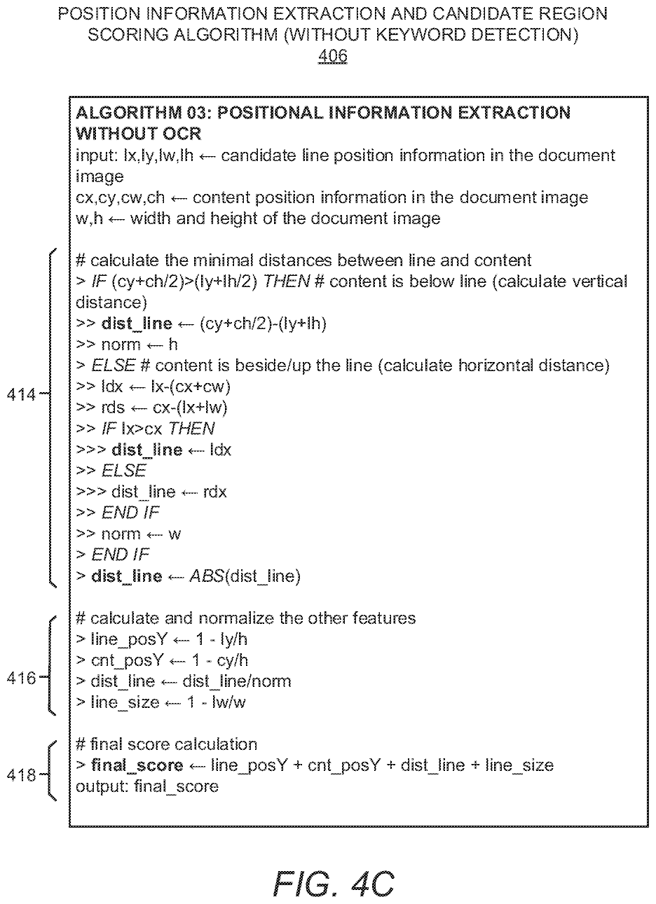

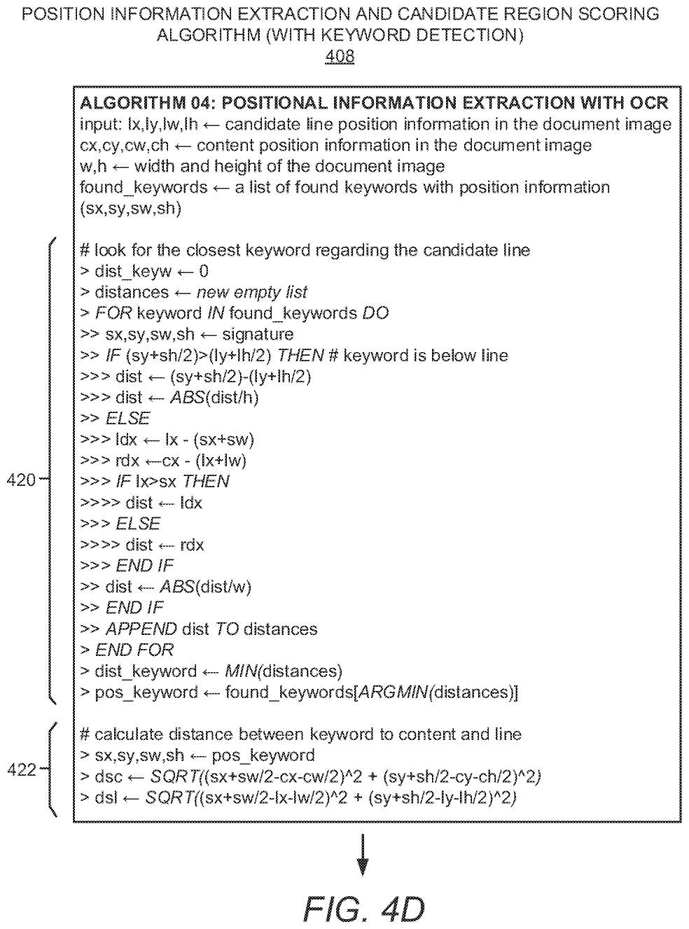

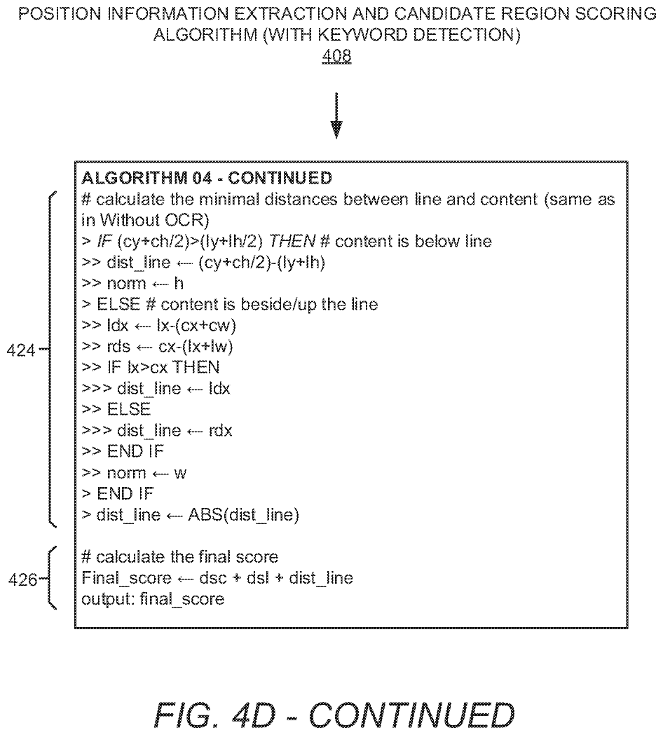

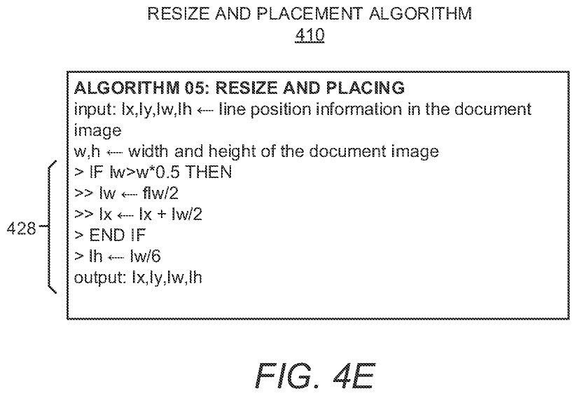

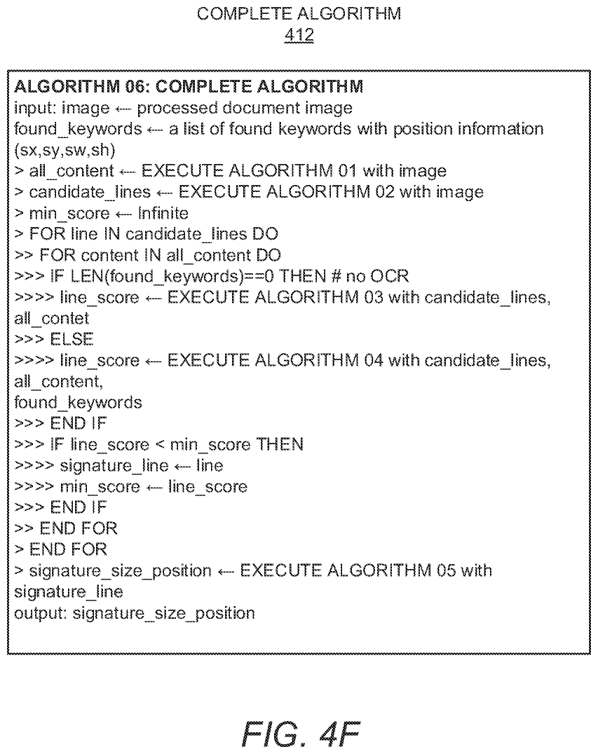

FIG. 4A shows a diagram of an example content detection algorithm 402 to identify contents in the image 208. FIG. 4B shows a diagram of an example candidate region detection algorithm 404 to identify candidate regions in the image 208. FIG. 4C shows a diagram of an example position information extraction and candidate region scoring algorithm 406 to extract relative position information of identified candidate regions with respect to respective identified contents in the image 208, and to generate scores for the identified candidate regions based on the relative position information. FIG. 4D shows a diagram of an example position information extraction and candidate region scoring algorithm 408 to extract relative position information of predefined keywords and identified candidate regions with respect to respective identified contents in the image 208, and to generate scores for the identified candidate regions based on the relative position information. FIG. 4E shows a diagram of an example content region resize and placement algorithm 410 to determine a size and a position of a selected candidate region to determine a size and a position of a predefined object, which may be placeable in the selected candidate region. FIG. 4F shows a diagram of an example complete algorithm 412 that includes the algorithms depicted in FIGS. 4A to 4E to output a determined size and a position of a predefined object on the image 208.

It should be understood that the example apparatus 100 depicted in FIG. 1, the example system 200 depicted in FIG. 2, the example images 208 depicted in FIGS. 3A and 3B, and the example algorithms 402 to 412 depicted in FIGS. 4A to 4F may include additional features and that some of the features described herein may be removed and/or modified without departing from the scopes of the apparatus 100, the system 200, the images 208, and the algorithms 402 to 412.

The apparatus 100 may be a scanner, a mobile handheld device, a tablet, a computing device, a photocopier, a facsimile device, and/or the like. As shown, the apparatus 100 may include a processor 102 and a non-transitory computer-readable medium, e.g., a memory 110. The processor 102 may be a semiconductor-based microprocessor, a central processing unit (CPU), an application specific integrated circuit (ASIC), a field-programmable gate array (FPGA), and/or other hardware device. Although the apparatus 100 is depicted as having a single processor 102, it should be understood that the apparatus 100 may include additional processors and/or cores without departing from a scope of the apparatus 100 and/or system 200. In this regard, references to a single processor 102 as well as to a single memory 110 may be understood to additionally or alternatively pertain to multiple processors 102 and/or multiple memories 110. As depicted in FIG. 2, the apparatus 100 may be implemented in a system 200, which may include a server 204 and a data store 206 with which the apparatus 100 may be in communication via a network 202.

The memory 110 may be an electronic, magnetic, optical, or other physical storage device that contains or stores executable instructions. The memory 110 may be, for example, Read Only Memory (ROM), flash memory, solid state drive, Random Access memory (RAM), an Electrically Erasable Programmable Read-Only Memory (EEPROM), a storage device, an optical disc, or the like. The memory 110 may be a non-transitory computer-readable medium. The term “non-transitory” does not encompass transitory propagating signals.

As shown in FIG. 1, the processor 102 may execute instructions 112-124 to identify candidate regions on an image at which a predefined object is placeable. The instructions 112-124 may be computer-readable instructions, e.g., non-transitory computer-readable instructions. In other examples, the apparatus 100 may include hardware logic blocks or a combination of instructions and hardware logic blocks to implement or execute functions corresponding to the instructions 112-124.

The processor 102 may fetch, decode, and execute the instructions 112 to receive an image 208. The image 208 may be an image of a document, which may be scanned or captured through use of an imaging device, such as a scanner, a camera on a mobile device, and/or the like. In some examples, the processor 102 may receive the image 208 from the imaging device, an external device, such as via electronic mail, or received from storage, such as the memory 110, the server 204, the data store 206, and/or the like.

The image 208 may be an image of a document, which may have specific regions or placeholders at which an object is to be inserted. By way of particular example and for purposes of illustration, the image 208 may be an image of a document that includes signature lines at which signature objects may be placeable. It should be understood that, while signature lines and signature objects are described herein for purposes of illustration, other types of regions or placeholders in images, at which various types of objects may be inserted, are within the scope of the present disclosure. For instance, the image 208 may have regions or place holders for check boxes, predefined text such as personal information including names, titles, addresses, email addresses, and/or the like, images such as logos, icons, avatars, pictures, and/or the like.

The processor 102 may fetch, decode, and execute the instructions 114 to identify contents 210 in the received image 208. The image 208 may include various types of items, such as text 302, graphical features such as lines 304, and/or the like. The processor 102 may process the items on the image 208 to identify the contents 210 and their respective sizes and positions on the image 208. In some examples, the processor 102 may divide the items on the image 208 into multiple contents 210. For instance, as depicted in FIG. 3A, the processor 102 may generate a contour of an area around certain groups of items on the image 208, such as characters.

By way of particular example and for purposes of illustration, the content 210 may be text 302 in the image 208-1. The processor 102 may divide the text 302 into certain regions. For instance, the processor 102 may divide the word “SAMPLE” into two different contents 210-2 and 210-3. In some examples, the processor 102 may define a region around an entire word, such as the text 302 “TEXT”, and may identify the region as a first content 210-1. The processor 102 may store position and size information of the identified contents 210 based on the determined contour of the contents 210.

By way of particular example and for purposes of illustration, as depicted in FIG. 4A, the processor 102 may apply various types of image processing techniques to detect contours of the contents 210. In some examples, the processor 102 may determine the contours, e.g., sizes and shapes, of the contents 210 based on positions of the items in the image 208, available processing resources, fidelity or accuracy of the position information, and/or the like. The processor 102 may exclude certain items when identifying the contents 210 in the image 208, for instance, to exclude or remove certain contours that may be smaller than a predefined threshold size. For instance, the processor 102 may exclude from the identified contents 210 items that have a width or height that is less than a predefined threshold size, such as the content 210-4 as depicted in FIG. 3A that includes a period, the lines 304 in the image 208, and/or the like.

The processor 102 may fetch, decode, and execute the instructions 116 to identify candidate regions 212 on the image 208 at which a predefined object 214 may be placeable. In some examples, the identified candidate regions 212 may correlate to the lines 304 on the image 208. By way of particular example and for purposes of illustration, as depicted in FIG. 3A, the identified candidate regions 212 may be the lines 304, in which the lines 304 may be signature lines. The predefined object 214, which may be placed on the lines 304, may be a signature object 306 such as a digital signature, a signature field box, and/or the like.

By way of particular example and for purposes of illustration, the processor 102 may apply the candidate region detection algorithm 404 depicted in FIG. 4B to identify the lines 304 and their respective positions on the image 208. In this particular example, the identified candidate regions 212 may be signature lines, such as lines 304. The processor 102 may apply various types of image processing techniques to detect the lines 304 in the image 208. The processor 102 may output a list of the lines 304 and respective position information of the lines 304 in the image 208.

The processor 102 may fetch, decode, and execute the instructions 118 to assign scores 218 to the identified candidate regions 212 based on relative positions of the identified candidate regions 212 to respective ones of the identified contents 210 in the image 208. The processor 102 may calculate the assigned scores 218 for respective ones of the identified candidate regions 212 based on a relative distance, which is also referred to herein as relative position information 216, between respective ones of the identified candidate regions 212 and each of the identified contents 210 in the received image 208. In some examples, for each of the identified candidate regions 212, the processor 102 may iterate through the identified contents 210, and may assign a score 218 for each candidate region 212 and identified content 210 pair based on their relative positioning on the image 208.

In some examples, the processor 102 may calculate a first score 218 for a first candidate region 212, which may be the same as the first line 304-1, among the identified candidate regions 212 with respect to the first content 210-1 based on a relative vertical position 308 of the first candidate region 304-1 on the image 208, a relative vertical position 310 of the first content 210-1 among the identified contents 210 on the image 208, a relative distance 312 between the first candidate region 304-1 and the first content 210-1, a relative horizontal width 314 of the first candidate region 304-1, or a combination thereof.

The relative positions of the candidate region 304-1 and the first content 210-1 may be determined relative to a reference point on the image 208, such as the predefined point 316 at the upper left corner of the image 208. The processor 102 may calculate a height 318 and a width 320 of the image 208 relative to the predefined point 316. In some examples, the relative positions may be calculated based on a vertical center of the candidate region 304-1 or the first content 210-1. For instance, the processor 102 may calculate the relative distance 312 between the first candidate region 304-1 and the first content 210-1 based on a vertical center point of the first content 210-1, e.g., vertical position Y of the first content 210-1 plus half the height of the first content 210-1.

In some examples, the processor 102 may calculate a value for the first score 218 based on a sum of the relative vertical position 308 of the first candidate region 304-1 on the image 208, the relative vertical position 310 of the first content 210-1 on the image 208, the relative distance 312 between the first candidate region 304-1 and the first content 210-1, and the relative horizontal width 314 of the first candidate region 304-1. The processor 102 may calculate a second score 218 for the first candidate region 304-1 with respect to the second content 210-2, and so on, for all of the identified contents 210.

By way of particular example and for purposes of illustration, the processor 102 may apply the position information extraction and candidate region scoring algorithm 406 to extract the relative position information 216 and to calculate the assigned scores 218 for the lines 304. The processor 102 may iterate through, for each of the lines 304, each of the contents 210 to apply the algorithm 406. For ease of explanation, this particular example will be described with respect to the first line 304-1, the first content 210-1, and the signature object 306, as depicted in FIG. 3B.

In this particular example, position information for each object may be defined by square regions with its horizontal corner position x, vertical corner position y, the width w, and the height h of the object. In some examples, the x and y position may correlate to an upper left corner of an object, measured with respect to a predefined point 316 on the image 208. For instance, the candidate line position information for the first line 304-1 may be defined by (lx, ly, lw, and lh), where lx is the horizontal position of the first line 304-1 relative to a predefined point 316 on the image 208, ly is the vertical position relative to the predefined point 316, lw is a width 320 of the image 208, and lh is a height 318 of the image 208. The position information for the first content 210-1 may be defined by (cx, cy, cw, ch), and the position information for keyword 222 may be defined by (sx, sy, sw, sh). The width 320 and the height 318 of the image 208 may be defined by w and h, respectively.

The processor 102 may apply section 414 of the algorithm 406 to calculate relative position information 216 for the first line 304-1 with respect to the first content 210-1. Continuing with the particular example with reference to the first line 304-1 and the first content 210-1, the processor 102 may determine the relative position information 216 to be a minimal distance between the first line 304-1 and the first content 210-1. The processor 102 may determine whether the first content 210-1 is positioned below the first line 304-1, as depicted in image 208-2 of FIG. 3A, or positioned beside or above the first line 304-1, as depicted in image 208-3 of FIG. 3A. Based on whether the content 210 is positioned below or beside the line 304, the processor 102 may determine the relative position information 216 for the minimal distance as depicted in section 414 of the algorithm 406.

The processor 102 may apply section 416 of the algorithm 406 to calculate and normalize the relative position information 216. The relative position information 216 may be normalized such that a value of the relative position information 216 may be between 0 and 1, in which a relatively smaller value may correlate to a relatively higher score 218. The processor 102 may apply the section 418 of the algorithm 406 to calculate the score 218, for instance, as a sum of the determined relative position information 216 for a vertical line position “line_posY”, a vertical content position “cnt_posY”, the minimal distance calculated in section 416, and a width of the first line 304.

In some examples, the processor 102 may identify predefined keywords 222 on the image 208. The processor 102 may identify the predefined keywords 222 in the image 208 based on various types of image processing, such as optical character recognition (OCR) and natural language processing (NLP). Based on a determination that the predefined keywords 222 are not present in the image 208, or in cases in which OCR may not be available, the processor 102 may calculate the scores 218 without the predefined keywords 222, as previously described with respect to the algorithm 406.

Based on a determination that predefined keywords 222 are present in the image 208, the processor 102 may select a keyword 222 among the identified predefined keywords 222, based on which the processor 102 may calculate the scores 218. The processor 102 may select the keyword 222 that is positioned closest to the first candidate region, which may be the same as the first line 304-1, among the identified candidate regions 212 or lines 304.

Based on the selected keyword 222, the processor 102 may calculate the first score 218 for the first candidate region 304-1, among the identified candidate regions 304 based on a relative distance 312 between the first candidate region 304-1 and the first content 210-1 among the identified contents 210, a relative distance 326 between the selected keyword 222 and the first content 210-1, a relative distance 324 between the selected keyword 222 and the first candidate region 304-1, or a combination thereof. In some examples, a region of the first content 210-1 may be the same as a region correlated to the selected keyword 222 or the first content 210-1 and the selected keyword 222 may correlate to different regions. The processor 102 may assign a relatively better score for the candidate region 304-1 that is positioned closer to the predefined keyword 222, than a candidate region 304-2, which may be positioned relatively farther to the predefined keyword 222.

In some examples, the processor 102 may calculate a value of the first score 218, based on the selected keyword 222, as a sum of the relative distance 312 between the first candidate region 304-1 and the first content 210-1, the relative distance 326 between the selected keyword 222 and the first content 210-1, and the relative distance 324 between the selected keyword 222 and the first candidate region 304-1.

Continuing with the particular example above with respect to the algorithm 406, in which the first line 304-1 may be a signature line, in instances in which a keyword 222 is found in the image 208, the processor 102 may apply the position information extraction and candidate region scoring algorithm 408 to calculate the assigned scores 218 based on a relative position of the keyword 222 to the first line 304-1 and the first content 210-1. The processor 102 may apply section 420 of the algorithm 408 to identify, among found keywords 222, the closest keyword 222 with respect to the first line 304-1. The processor 102 may determine whether the keyword 222 is positioned below the first line 304-1, left of the first line 304-1, or right of the first line 304-1. Based on the determined position of the keyword 222, the processor 102 may identify the keyword 222 among the found keywords 222 as being positioned closest to the first line 304-1.

The processor 102 may apply section 422 of the algorithm 408 to calculate the relative position information 216 between the keyword 222, the first content 210-1, and the first line 304-1. For instance, the processor 102 may calculate the relative position information 216, including a relative distance “dsc” between the keyword 222 and the first content 210-1 and a relative distance “dsl” between the keyword 222 and the first line 304-1. The processor 102 may apply section 424 of the algorithm 408 to calculate a minimal distance between the first line 304-1 and the content 210-1. In this regard, the section 424 of the algorithm 408 may be the same as the section 414 of the algorithm 406. The processor 102 may apply section 426 to calculate the score 218 for the first line 304-1 with respect to the first content 210-1 and the keyword 222. The processor 102 may calculate the score 218 to be a sum of the relative distance “dist_line” between the first line 304-1 and the first content 210-1, the relative distance “dsc” between the selected keyword 222 and the first content 210-1, and the relative distance “dsl” between the selected keyword 222 and the first line 304-1.

The processor 102 may apply the algorithm 408 to calculate the relative positional information 216 for a particular line 304 with respect to a particular content 210 among the contents 210, such as a minimal distance between the particular line 304 and the particular content 210. The processor 102 may determine whether the content 210 is positioned below the particular line 304, or positioned beside or above the particular line 304. The processor 102 may determine the relative positional information for the minimal distance based on the relative position of the content 210 to the particular line 304.

The processor 102 may apply section 416 of the algorithm 406 to calculate and normalize the relative position information 216. The relative position information 216 may be normalized such that a relative smaller value may correlate to a higher score 218. The processor 102 may apply section 418 to calculate the score 218, for instance, as a sum of the determined relative position information 216 for a vertical line position “line_posY”, a vertical content position “cnt_posY”, the minimal distance calculated in section 416, and a width of the first line 304-1.

The processor 102 may fetch, decode, and execute the instructions 120 to select a candidate region 220, such as the first candidate region 212, among the identified candidate regions 212 at which the predefined object 214, such as the signature object 306, may be placed based on the assigned scores 218. The processor 102 may rank the assigned scores 218 correlated to a candidate region 212 for respective contents 210, and may select the candidate region 220 having the relatively highest ranked score 218. In some examples, lower values of the scores 218, which may correlate to closer relative positioning on the image 208, may be ranked higher.

The processor 102 may fetch, decode, and execute the instructions 122 to determine a size and a position 224 of the predefined object 214 based on the selected candidate region 220. In some examples, the size and the position 224 of the predefined object 214 may correlate to a size and a position of the selected candidate region 220. For instance, the size of the predefined object 214 may correlate to a width 314 of the first line 304-1, and the position of the predefined object 214 may correlate to a center of the first line 304-1.

The processor 102 may resize or reposition the first line 304-1, which may correlate to a change in the size and the position 224 of the predefined object 214. In some examples, the processor 102 may resize the selected candidate region 220 based on a width 302-1 of the selected candidate region 220 and a width 320 of the image 208. The processor 102 may determine the size of the predefined object 214 based on a size of the resized selected candidate region 220.

Continuing with the particular example above with respect to the first line 304-1 and the first content 210-1, the processor 102 may apply the resize and placement algorithm 410 to determine a size and a position of a signature line, which may be the same as the first line 304-1. For instance, in a case in which a width 314 of the first line 304-1 is greater than a predefined threshold value, for instance, half of the width 320 of the image 208, the processor 102 may reduce the width 314 of the first line 304-1.

The processor 102 may fetch, decode, and execute the instructions 124 to output the determined size and the position 224 of the predefined object 214 to be placed on the image 208. In some examples, the processor 102 may insert the predefined object 214, such as the signature object 306, at the selected candidate region 220 on the image 208 based on the determined size and the position 224 of the predefined object 214. In some examples, the processor 102 may add a graphical object, such as a signature field box, indicating the selected candidate region 220 on the image 208. As depicted in FIG. 4F, the processor 102 may apply the complete algorithm 412 to apply algorithms 402 to 410 as previously described. Based on the algorithm 412, the processor 102 may output the size and position 224 of the signature object 306 to be placed on the image 208.

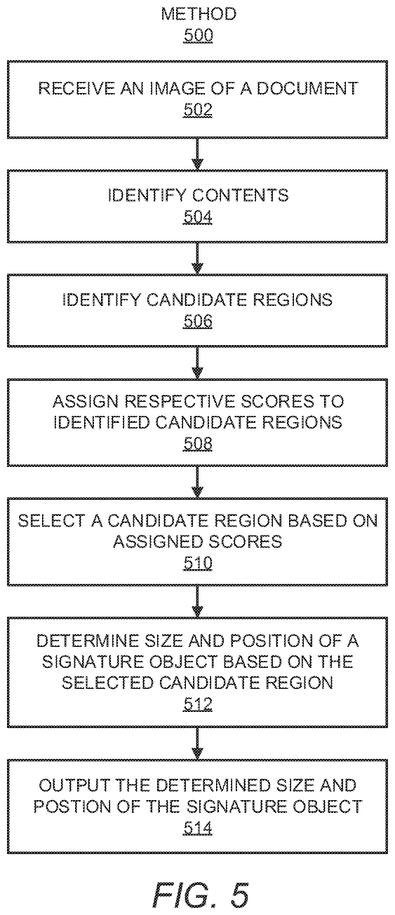

Various manners in which the processor 102 may operate are discussed in greater detail with respect to the method 500 depicted in FIG. 5. FIG. 5 depicts a flow diagram of an example method 500 for selecting a candidate region 220 among identified candidate regions 212 on an image 208 and determining a size and a position 224 of a predefined object 214 based on the selected candidate region 220. It should be understood that the method 500 depicted in FIG. 5 may include additional operations and that some of the operations described therein may be removed and/or modified without departing from the scope of the method 500. The description of the method 500 is made with reference to the features depicted in FIGS. 1, 2, 3A, 3B, and 4A to 4F for purposes of illustration.

At block 502, the processor 102 may receive an image 208 of a document. The image 208 may include various types of items, such as text 302, lines 304, predefined keywords 222, and/or the like.

At block 504, the processor 102 may identify contents 210 in the received image 208. The processor 102 may process the items included in the image 208 and may define regions around the items to identify the multiple contents 210 in the image and their respective positions and sizes.

At block 506, the processor 102 may identify candidate regions 212 in the image 208 at which a predefined object 214, such as the signature object 306, may be insertable. In some examples, the candidate regions 212 may be signature lines, such as lines 304 depicted in FIGS. 3A and 3B.

At block 508, the processor 102 may assign, for each of the identified contents 210, respective scores 218 to the identified candidate regions 212 based on relative positions, such as based on the relative position information 216, of the identified candidate regions 212 with respect to a respective one of the identified contents 210 in the image 208.

At block 510, the processor 102 may select a candidate region 212, such as the first line 304-1 depicted in FIGS. 3A and 3B, among the identified candidate regions 212 at which the signature object 306 is to be inserted.

At block 512, the processor 102 may determine a size and a position 224 of the signature object 306 based on the selected candidate region 212. At block 514, the processor 102 may output the determined size and the position 224 of the signature object 306 on the image 208.

In some examples, the identified candidate regions 212 may correlate to the identified lines 304 on the image 208. The processor 102 may identify the lines 304 on the image 208 as the candidate regions 212.

In some examples, the processor 102 may identify a predefined keyword 222 on the image 208. The processor 102 may apply various types of image processing techniques, such as OCR, to identify the predefined keyword 222. Based on a determination that the predefined keyword 222 is present in the image 208, the processor 102 may calculate a first score 218 for a first candidate region 304-1 among the identified candidate regions 212 based on a relative distance between the identified predefined keyword 222, the first candidate region 304-1, and a first content 210-1 among the identified contents 210. For each of the candidate regions 212, the processor 102 may iteratively calculate the score 218 with respect to each of the contents 210. The processor 102 may select a candidate region 212 among the identified candidate regions 212 based on a ranking of the scores 218.

In some examples, the processor 102 may resize the selected candidate region 212, such as the line 301-1, based on a width 314 of the line 301-1 and a width 320 of the image 208. The processor 102 may determine the size and the position 224 of the signature object 306 based on a size and a position of the resized selected candidate region 212.

Some or all of the operations set forth in the method 500 may be included as utilities, programs, or subprograms, in any desired computer accessible medium. In addition, the method 500 may be embodied by computer programs, which may exist in a variety of forms both active and inactive. For example, they may exist as computer-readable instructions, including source code, object code, executable code or other formats. Any of the above may be embodied on a non-transitory computer-readable storage medium.

Examples of non-transitory computer-readable storage media include computer system RAM, ROM, EPROM, EEPROM, and magnetic or optical disks or tapes. It is therefore to be understood that any electronic device capable of executing the above-described functions may perform those functions enumerated above.

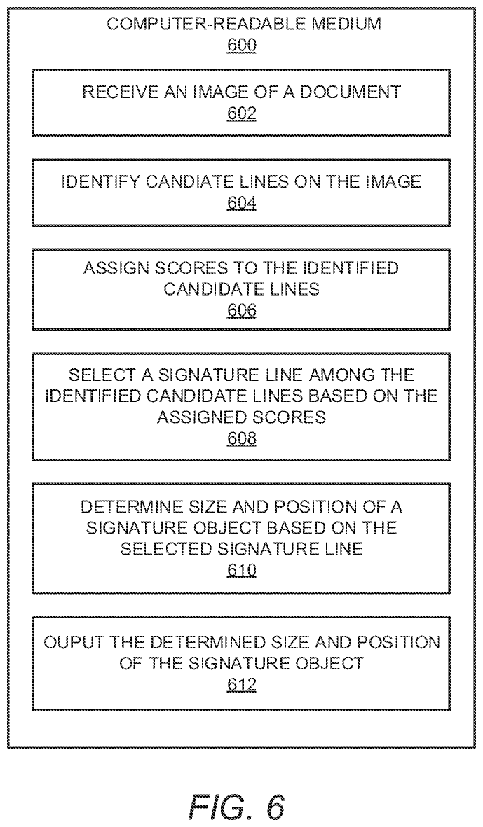

Turning now to FIG. 6, there is shown a block diagram of a non-transitory computer-readable medium 600 that may have stored thereon machine readable instructions that when executed by a processor, may cause the processor to select a signature line, such as the candidate region 304-1, depicted in FIGS. 3A and 3B, among identified candidate lines 304 on an image 208, and to determine a size and a position 224 of a signature object 306, based on the selected signature line, such as the line 304-1. It should be understood that the computer-readable medium 600 depicted in FIG. 6 may include additional instructions and that some of the instructions described herein may be removed and/or modified without departing from the scope of the computer-readable medium 600 disclosed herein. The computer-readable medium 600 may be a non-transitory computer-readable medium. The term “non-transitory” does not encompass transitory propagating signals.

The computer-readable medium 600 may have stored thereon computer-readable instructions 602-612 that a processor, such as the processor 102 depicted in FIGS. 1-2, may execute. The computer-readable medium 600 may be an electronic, magnetic, optical, or other physical storage device that contains or stores executable instructions. The computer-readable medium 600 may be, for example, Random-Access memory (RAM), an Electrically Erasable Programmable Read-Only Memory (EEPROM), a storage device, an optical disc, or the like.

The processor may fetch, decode, and execute the instructions 602 to receive an image 208 of a document. The image 208 may be received via an imaging device, the memory 110, a computing device, such as the server 204, the data store 206, and/or the like.

The processor may fetch, decode, and execute the instructions 604 to identify candidate lines 304 on the image 208 at which a signature object 306 may be insertable in the image 208 of the document.

The processor may fetch, decode, and execute the instructions 606 to assign scores 218 to the identified candidate lines 304 based on relative positions of respective ones of the identified candidate lines 304 to respective contents 210 in the image 208.

The processor may fetch, decode, and execute the instructions 608 to select a signature line, which may be the first line 304-1, among the identified candidate lines 304 at which the signature object 306 may be insertable based on the assigned scores 218.

The processor may fetch, decode, and execute the instructions 610 to determine a size and a position 224 of the signature object 306 based on the selected signature line 304-1. In some examples, the size and the position 224 of the signature object 306 may correlate to a size and a position of the signature line 304-1 on the image 208.

The processor may fetch, decode, and execute the instructions 612 to output the determined size and the position 224 of the signature object 306 on the image 208. In some examples, the processor may output coordinate and size information for the signature object 306. In some examples, the processor may generate a graphical object to indicate a signature field on the selected signature line 304-1. The processor may modify the signature object 306 based on inputs to resize or move the signature object 306 in the signature field.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor, cause the processor to:
receive an image;
identify contents in the received image;
identify candidate regions in the received image at which a predefined object is placeable;
assign scores to the identified candidate regions based on relative positions of the identified candidate regions to respective ones of the identified contents in the received image;
based on the assigned scores, select a candidate region among the identified candidate regions at which the predefined object is to be placed;
determine a size and a position of the predefined object based on the selected candidate region; and
output the determined size and the position of the predefined object on the received image.

2. The apparatus of claim 1, wherein the instructions cause the processor to:
identify lines on the received image, wherein the identified candidate regions correlate to the identified lines on the received image.

3. The apparatus of claim 1, wherein the instructions cause the processor to:
calculate the assigned scores for respective ones of the identified candidate regions based on a relative distance between the respective ones of the identified candidate regions and each of the identified contents in the received image.

4. The apparatus of claim 3, wherein the instructions cause the processor to:
calculate a first score for a first candidate region among the identified candidate regions based on a relative vertical position of the first candidate region on the received image, a relative vertical position of a first content among the identified contents on the received image, a relative distance between the first candidate region and the first content, a relative horizontal width of the first candidate region, or a combination thereof.

5. The apparatus of claim 4, wherein a value of the first score is a sum of the relative vertical position of the first candidate region on the received image, the relative vertical position of the first content on the received image, the relative distance between the first candidate region and the first content, and the relative horizontal width of the first candidate region.

6. The apparatus of claim 3, wherein the instructions cause the processor to:
identify predefined keywords on the received image;
select a keyword among the identified predefined keywords, the selected keyword being positioned closest to a first candidate region among the identified candidate regions; and
based on the selected keyword, calculate a first score for the first candidate region among the identified candidate regions based on a relative distance between the first candidate region and a first content among the identified contents, a relative distance between the selected keyword and the first content, a relative distance between the selected keyword and the first candidate region, or a combination thereof.

7. The apparatus of claim 6, wherein a value of the first score is a sum of the relative distance between the first candidate region and the first content, the relative distance between the selected keyword and the first content, and the relative distance between the selected keyword and the first candidate region.

8. The apparatus of claim 1, wherein the instructions cause the processor to:
resize the selected candidate region based on a width of the selected candidate region and a width of the received image; and
determine the size of the predefined object based on a size of the resized selected candidate region.

9. A method comprising:
receiving, by a processor, an image of a document;
identifying, by the processor, contents in the received image;
identifying, by the processor, candidate regions on the received image at which a signature object is insertable;
assigning, by the processor for each of the identified contents, respective scores to the identified candidate regions based on relative positions of the identified candidate regions with respect to a respective one of the identified contents in the image;
based on the assigned scores, selecting, by the processor, a candidate region among the identified candidate regions at which the signature object is to be inserted;
determining, by the processor, a size and a position of the signature object based on the selected candidate region; and
outputting, by the processor, the determined size and the position of the signature object to be inserted on the received image.

10. The method of claim 9, further comprising:
identifying lines on the received image, wherein the identified candidate regions correlate to the identified lines on the received image.

11. The method of claim 9, further comprising:
identifying a predefined keyword on the received image; and
based on the identified predefined keyword, calculating a first score for a first candidate region among the identified candidate regions based on a relative distance between the identified predefined keyword, the first candidate region, and a first identified content among the identified contents.

12. The method of claim 9, further comprising:
resizing the selected candidate region based on a width of the selected candidate region and a width of the received image; and
determining the size and the position of the signature object based on a size and a position of the resized selected candidate region.

13. A non-transitory computer-readable medium on which is stored machine-readable instructions that when executed by a processor, cause the processor to:
receive an image of a document;
identify candidate lines on the received image at which a signature object is insertable in the received image;
assign scores to the identified candidate lines based on relative positions of respective ones of the identified candidate lines to respective contents in the received image;
based on the assigned scores, select a signature line among the identified candidate lines at which the signature object is insertable;
determine a size and a position of the signature object based on the selected signature line; and
output the determined size and the position of the signature object on the received image.

14. The non-transitory computer readable medium of claim 13, wherein the instructions cause the processor to:
calculate a first score for a first candidate line among the identified candidate lines based on a relative distance between the first candidate line and a first content among the respective contents; and
select the signature line based on the calculated first score for the first candidate line.

15. The non-transitory computer readable medium of claim 13, wherein the instructions cause the processor to:
resize the selected signature line based on a width of the selected signature line and a width of the received image; and
determine the size and the position of the signature object based on a size and a position of the resized selected signature line.
